(19) United States
(12) Patent Application Publication
(10) Pub. No.: US 2009/0032572 A1
(43) Pub. Date: Feb. 5, 2009

(54) System, method, and apparatus for reactive foil brazing of rock bit components. Hardfacing and compacts

(76) Inventors: Andy Oxfdord, Magnolia, TX (US); Mathews George, Houston, TX (US); Curtis A. Proske, The Woodlands, TX (US)

Correspondence Address: BRACEWELL & GIULIANI LLP, P.O. BOX 61389, HOUSTON, TX, 77208-1389, US

(21) Appl. No.: 11/890,067

(22) Filed: Aug. 3, 2007

(51) Int. Cl. B23K 31/02

(52) U.S. Cl. 228/198

(57) ABSTRACT

A reactive foil is used to join rock bit components such as leg sections, hardfacing, and cutter elements to the rolling cone earth-boring bit body. A small pulse of localized energy ignites the foil in a fraction of second to deliver the necessary amount of heat energy to reflow solder or braze and form a strong, true metallic joint. The reaction in the foil may be activated using optical, electrical, or thermal sources.

### BACKGROUND OF THE INVENTION

1. Technical Field

The present invention relates in general to fabricating rolling cone earth-boring bits and, in particular, to an improved system, method, and apparatus for brazing together the components of rock bits, such as leg sections, with reactive foil and similar joining techniques for hardfacing and compacts on rock bits.

2. Description of the Related Art

In the prior art, typically earth-boring bits are assembled and hardface materials are applied to the bits with conventional welding techniques. There are several problems associated with these processes. For example, conventional welding heats the rock bit heads in a manner that is uncontrolled. Any variation in the way that operators complete the welding requirements produces varying results. Moreover, sections of the rock bit are heated to temperatures that change the properties of the metal. In particular, the shirt tail regions of the head may tend to have a reduced integrity due to conventional welding, and therefore also must be applied prior to heat treatment. This sequence does not allow for repair or revisions to the bit once it is heat treated. The manual weld patterns are difficult to produce to resemble the design and pattern of the head design, which results in numerous manufacturing pitfalls and inconsistencies. Furthermore, automated welding operations and materials also can produce an unreliable manufacturing process.

In addition, conventional compact retention in rock bits comprises interference fits between the carbide compacts and the steel components. This type of processing typically encounters a number of common problems. High tensile stresses are imposed around the compact holes and can lead to cone cracking and thereby limit the ability of designers to prescribe compact placement. Problems are also encountered during pressing that lead to gapped compact holes, which lead to the loss of compacts during drill bit operation and the corrosion-assisted loss of compacts. Moreover, some applications require special sizes of compacts to be designed and inventoried to salvage cones with over-sized holes. Additionally, the high temperatures experienced during conventional brazing destroy the heat treatment of components. Thus, an improved system for joining the various components of rock bits that overcomes the limitations of conventional processes would be desirable.

### SUMMARY OF THE INVENTION

Embodiments of a system, method, and apparatus for joining rock bit components with a reactive foil are disclosed. A small pulse of localized energy ignites the foil in a fraction of second to deliver the necessary amount of heat energy to reflow solder or braze (e.g., Ag—Cu) and form a strong, true metallic joint. The reaction in the foil may be activated using optical, electrical, or thermal sources.

For example, an effective bond may be formed between the steel body of a rock bit and its tungsten carbide cutting elements using these techniques. Other embodiments include forming bonds between hardfacing components and the rock bit, as well as joining leg sections of the rock bit to form the rock bit body. These techniques eliminate the need for a standard furnace, torch, or laser weld. Bonds between similar or dissimilar materials (e.g., ceramics to metals) may be formed in almost any environment (e.g., in ambient conditions), and are resistant to corrosion and degradation. The bonds exert low stress on the constituent parts, expose them to minimal thermal demands, and are flux free.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention, which will become apparent, are attained and can be understood in more detail, more particular description of the invention briefly summarized above may be had by reference to the embodiments thereof that are illustrated in the appended drawings which form a part of this specification. It is to be noted, however, that the drawings illustrate only some embodiments of the invention and therefore are not to be considered limiting of its scope as the invention may admit to other equally effective embodiments.

FIG. 1 is an isometric view of one embodiment of an earth-boring bit constructed in accordance with the invention;

FIG. 2 is an exploded isometric view of one embodiment of a hardface configuration for a portion of a bit and is constructed in accordance with the invention;

FIG. 3 is an isometric view of one embodiment of the leg sections assembly for a bit constructed in accordance with the invention;

FIG. 4 is a sectional view of one embodiment of a compact brazed in a machined hole in a bit constructed in accordance with the invention;

FIGS. 5A-C are schematic sectional view of various embodiments of joint and material configurations for drill bits and are constructed in accordance with the invention; and

FIG. 6 is a high level flow diagram of one embodiment of a method in accordance with the invention.

### DETAILED DESCRIPTION OF THE INVENTION

Embodiments of a system, method and apparatus for reactively brazing together the components of rock bits, such as leg sections, and reactively brazing hardfacing and compacts on rock bits are disclosed. The invention utilizes technology disclosed in U.S. Patent Application Nos. 2004/0149373, published on Aug. 5, 2004; 2004/0247931, published on Dec. 9, 2004; 2005/0003228, published on Jan. 6, 2005; and 2006/0219759, published on Oct. 5, 2006, all of which are incorporated herein by reference.

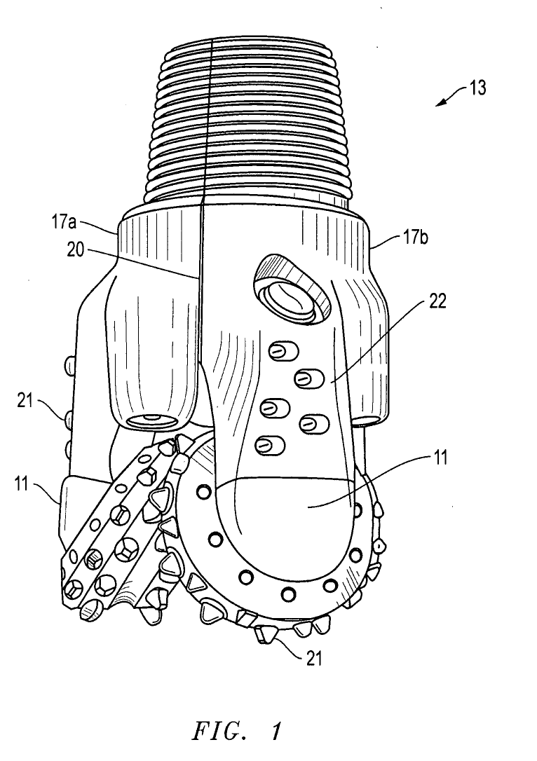

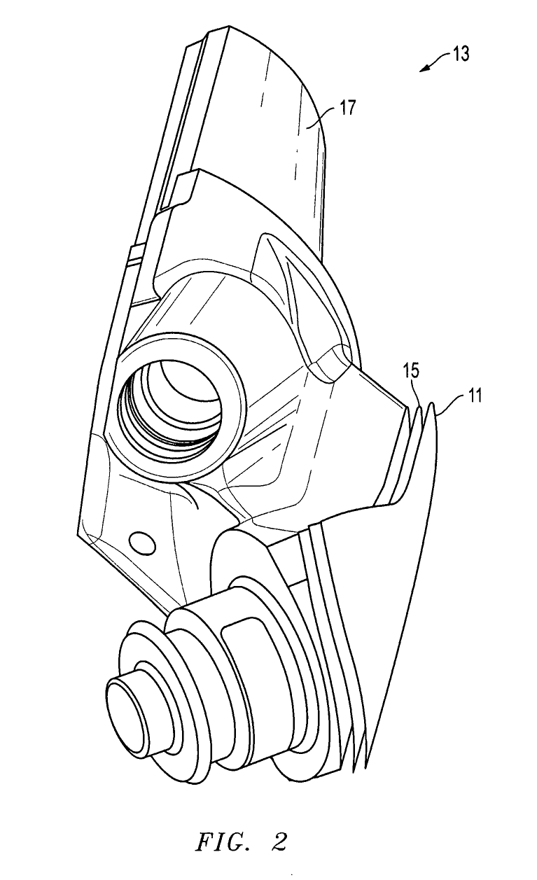

The use of such materials and techniques to braze and/or solder process rock bit components replaces the conventional welding processes employed in constructing rock bit products. In one embodiment (FIGS. 1 and 2), hardfacing material 11 such as wear pads having desired physical properties (e.g., toughness, wear resistance, etc.), are secured to rock bits 13 with a reactive brazing technology. This technique eliminates: (1) the need for welding hardfacing on tricone rock bits; (2) inconsistencies in hardfacing placement during welding; (3) welding defects such as porosity; and (4) heat-affected zones and undesired phase changes due to traditional welding/brazing processes. In addition, this technique allows experimentation and development of wear pads utilizing virtually unlimited material selection to obtain unsurpassed bit life.

The wear pads may be machined, stamped, or cast to design requirements and reactively brazed in place. This technique is much more precise (e.g., within tolerances of approximately 0.010 inches) than conventional welding techniques (e.g., within tolerances of approximately 0.030 inches) and does not degrade the parent material to produce a higher performing rock bit. The shirt tail region of the head (see hardfacing material 11 in FIG. 1) is particularly well suited for the invention due to its relatively thin cross-section which can be affected by the extreme temperatures faced during conventional welding. Moreover, there is limited ability to position weld material close enough to the critical areas of the shirt tail to prevent excessive wear, which can result in premature failure of bearings due to contaminated grease.

Another significant advantage of this process is the avoidance of having to weld together the head sections early in the manufacturing process. Rather, a critical lean approach may be taken to utilize other flow tools to reduce lead times in the manufacturing process. Heads may be standardized or grouped into better process families throughout a majority of the manufacturing process. By utilizing this lean concept and being able to apply customized hardface pads at the end of the process (e.g., at final assembly), lead times for manufacturing rock bits may be significantly reduced.

In one embodiment, hardfacing pads 11 are located on the rock bit body with precision, with the reactive foil 15 (FIG. 2) and braze alloy in place between the pads 11 and the body 13. Physical pressure (e.g., on the order of 700 psi) is applied to the parts and a small, localized energy pulse or other ignition source reflows the metallic foil in milliseconds to produce a strong metallic joint that results in a very strong, completed braze that is cool to the touch in less than one second. This process only heats the immediate surface of the materials being joined and does not degrade any heat treatment or change any properties of the parts. The braze and/or solder material may comprise, for example, Ag—Cu, Ni—Al, Al—Si, Zn—Al, etc. The reaction in the foil may be activated with a small pulse of localized energy that can be applied using optical, electrical, or thermal sources, such as electrical pulse, spark, hot filament, laser beam, etc.

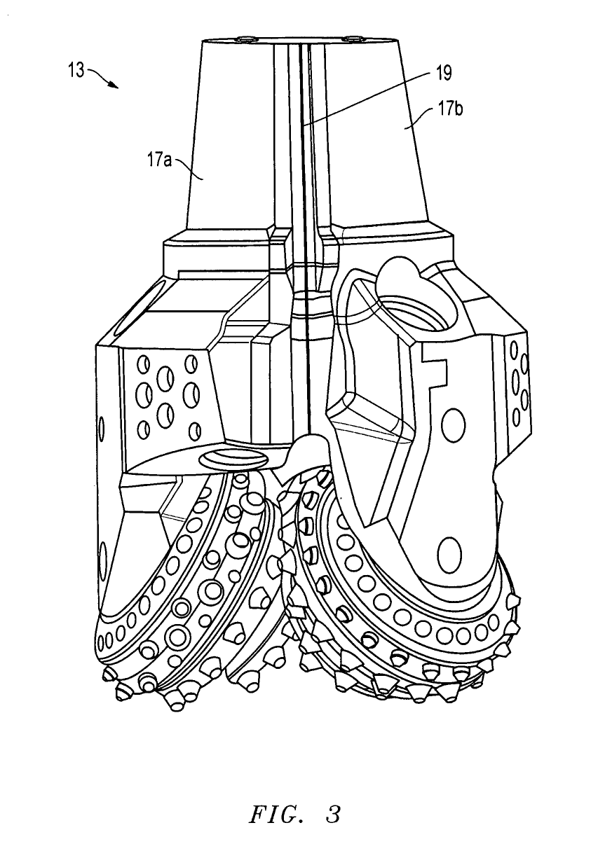

Referring now to FIG. 3, another embodiment of the invention comprises a system, method and apparatus for reactively brazing together rock bit components, such as leg sections 17. The foil 19 and braze alloy are positioned between the leg sections 17a, 17b and a body of the rock bit, and is then reflowed as described herein to form a strong bond 20 (FIG. 1) therebetween. Such techniques reduce processing time, eliminate welding material and equipment, and provide a safer operation for personnel.

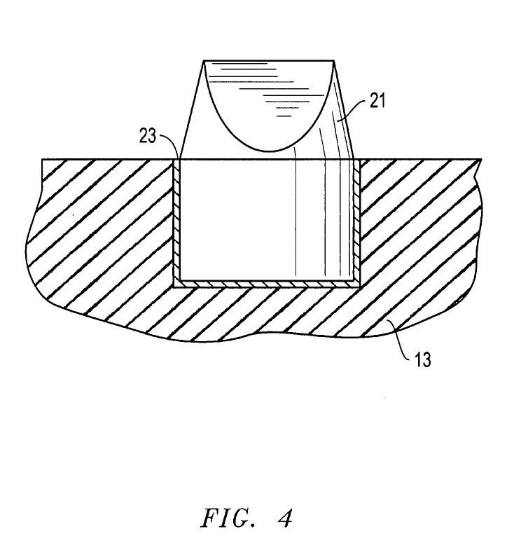

As shown in FIGS. 1 and 4, the invention also comprises a system, method and apparatus for reactively brazing compacts 21 (e.g., tungsten carbide cutting elements) into cones and the head OD 22 on rock bits 13. The brazing material 23 and reactive foil (FIG. 4) is used in a braze/solder process to replace the conventional interference fit of cutting and wear elements in rock bits. This process alleviates the high residual stresses around the compact holes that are prone to cracking. The invention also resolves compact retention issues from corrosion and bad pressing, and allows for designs with closer spacing between compacts since post-processing stresses are virtually eliminated. Accordingly, the need for compact pressing equipment also is eliminated, as is the need for the EDM equipment used to burn out compacts during the salvage process, thereby reducing capital expenses for manufacturing.

The reactive brazing process is quicker than conventional techniques and lends itself to high volume production since the cutters may be readily placed in the rock bit pockets by hand with the reactive foil. Activation of the film is accomplished as described herein using a small pulse of localized energy that occurs in milliseconds. This technique only heats the surface of the pocket and the surface of the compact without destroying the steel heat treatment of the adjacent material.

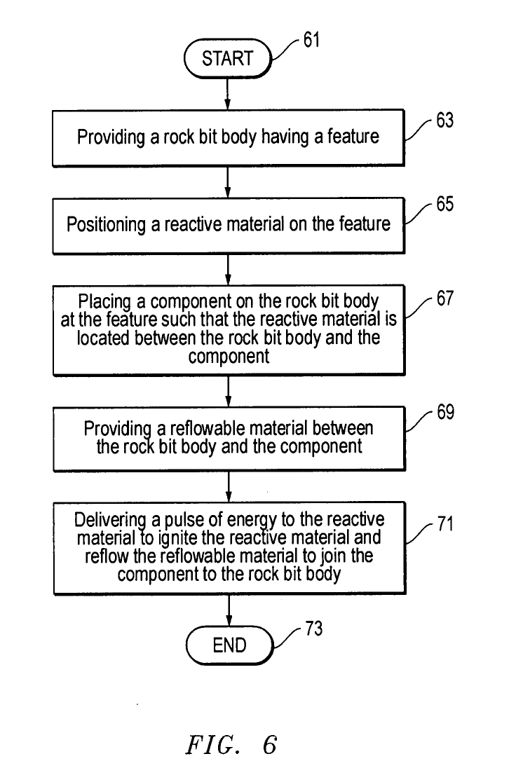

Referring now to FIG. 6, one embodiment of the invention includes a method of joining components of a rock bit. The method begins as indicated at step 61, and comprises providing a rock bit body having a feature (step 63); positioning a reactive material (e.g., foil) on the feature (step 65); placing a component on the rock bit body at the feature such that the reactive material is located between the rock bit body and the component (step 67); providing a reflowable material between the rock bit body and the component (step 69); and delivering a pulse of energy to the reactive material to ignite the reactive material and reflow the reflowable material to join the component to the rock bit body (step 71), before ending as indicated at step 73.

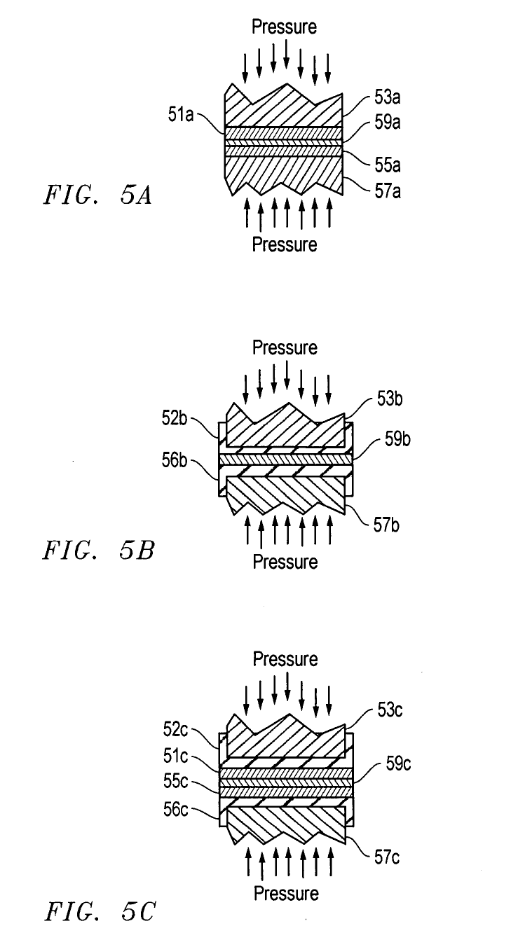

As described above, the feature and component may comprise many different elements of a bit. The reflowable material may comprise an alloy material containing, for example, Ag, Cu, Al, Ni, Au, Zn, Sn, or Ti. As shown in FIG. 5A, the reflowable material may comprise a first braze alloy foil 51a located adjacent to the component 53a, a second braze alloy foil 55a located adjacent to the feature 57a, and the reactive material 59a may be located between the first and second braze alloy foils 51a, 55a.

Alternatively (FIG. 5B), the component 53b and the feature 57b may be coated with a braze or solder alloy material 52b, 56b, respectively, before assembly with reactive material 59b. In another alternate embodiment (FIG. 5C), separate braze alloy foils 51c, 55c, may be positioned adjacent the respective coatings 52c, 56c on component 53c and feature 57c prior to assembly with reactive material 59c. The different coatings may comprise the same materials or different materials depending on the application. Similarly, the coatings and braze alloy foils may comprise the same or different materials. The method may further comprise preheating the component and the feature and applying a load between the rock bit body and the component before assembly.

While the invention has been shown or described in only some of its forms, it should be apparent to those skilled in the art that it is not so limited, but is susceptible to various changes without departing from the scope of the invention.

What is claimed is:

1. A method of joining components of a rock bit, comprising:
(a) providing a rock bit body having a feature;
(b) positioning a reactive material on the feature;
(c) placing a component on the rock bit body at the feature such that the reactive material is located between the rock bit body and the component;
(d) providing a reflowable material between the rock bit body and the component; and
(e) delivering a pulse of energy to the reactive material to ignite the reactive material and reflow the reflowable material to join the component to the rock bit body.

2. A method according to claim 1, wherein the feature comprises a leg section pad, and the component comprises a leg section.

3. A method according to claim 1, wherein the feature comprises a hardfacing location on a cone and a head outer diameter of the rock bit body, and the component comprises a wear pad formed from hardfacing material.

4. A method according to claim 3, wherein the wear pad is formed by a technique selected from the group consisting of machining, stamping and casting.

5. A method according to claim 1, wherein the feature comprises a pocket in the rock bit body, and the component comprises a tungsten carbide cutting element.

6. A method according to claim 1, wherein the feature is located on a shirt tail of the rock bit body.

7. A method according to claim 1, wherein step (e) requires less than one second.

8. A method according to claim 1, wherein the reflowable material comprises an alloy material selected from the group consisting of Ag, Cu, Al, Ni, Au, Zn, Sn, and Ti.

9. A method according to claim 1, wherein the pulse of energy is applied with one of an optical, electrical, and thermal source.

10. A method according to claim 1, wherein the pulse of energy is selected from the group consisting of an electrical pulse, a spark, a hot filament, and a laser beam.

11. A method according to claim 1, wherein the reflowable material comprises a first braze alloy foil located adjacent to the component, a second braze alloy foil located adjacent to the feature, and the reactive material is located between the first and second braze alloy foils.

12. A method according to claim 1, further comprising coating the component and the feature with a braze or solder alloy material before step (b).

13. A method according to claim 1, further comprising preheating the component and the feature, and applying a load between the rock bit body and the component before step (e).

14. A method of joining components of a rock bit, comprising:
(a) providing a rock bit body having a feature;
(b) positioning a reactive foil on the feature;
(c) placing a component on the rock bit body at the feature such that the reactive foil is located between the rock bit body and the component;
(d) providing a reflowable alloy between the rock bit body and the component;
(e) applying a load between the rock bit body and the component; and
(f) delivering a pulse of energy to the reactive foil to ignite the reactive foil and reflow the reflowable alloy to join the component to the rock bit body in less than one second.

15. A method according to claim 14, wherein the feature comprises a leg section pad, and the component comprises a leg section, and further comprising preheating the component and the feature.

16. A method according to claim 14, wherein the feature comprises a hardfacing location on a cone and a head outer diameter of the rock bit body, the component comprises a wear pad formed from hardfacing material, and the wear pad is formed by a techniques selected from the group consisting of machining, stamping and casting.

17. A method according to claim 14, wherein the feature comprises a pocket in the rock bit body, and the component comprises a tungsten carbide cutting element.

18. A method according to claim 14, wherein the feature is located on a shirt tail of the rock bit body, and wherein the reflowable alloy comprises an alloy material selected from the group consisting of Ag, Cu, Al, Ni, Au, Zn, Sn, and Ti.

19. A method according to claim 14, wherein the pulse of energy is applied with one of an optical, electrical, and thermal source, and wherein the pulse of energy is selected from the group consisting of an electrical pulse, a spark, a hot filament, and a laser beam.

20. A method according to claim 14, wherein the reflowable alloy comprises a first braze alloy foil located adjacent to the component, a second braze alloy foil located adjacent to the feature, and the reactive foil is located between the first and second braze alloy foils.

21. A method according to claim 14, further comprising coating the component and the feature with a braze or solder alloy material before step (b).
